(19) United States
(12) Patent Application Publication
(10) Pub. No.: US 2022/0281690 A1
(43) Pub. Date: Sep. 8, 2022

(54) A SENSOR ASSEMBLY AND MONITORING SYSTEM FOR AN IDLER ROLLER IN A BELT CONVEYOR SYSTEM

(71) Applicant: MINESENSOR ASSETS PTY LTD., Tramarama, New South Wales (AU)

(72) Inventors: David John Bull, Castle Hill, New South Wales (AU); Craig Anthony Wheeler, Fishing Point, New South Wales (AU); James Phillip Bull, Castle Hill, New South Wales (AU); Stephan Hans Meyer, Elanora Heights, New South Wales (AU)

(21) Appl. No.: 17/634,569

(22) PCT Filed: Aug. 12, 2020
(86) PCT No.: PCT/AU2020/050837

§ 371 Date: Feb. 11, 2022

(30) Foreign Application Priority Data
Aug. 13, 2019 (AU) 2019902916

(51) Int. Cl. B65G 43/02; B65G 39/09; G01M 13/045; H02K 35/02; H01Q 1/22; H01Q 19/17

(52) U.S. Cl. CPC B65G 43/02; B65G 39/09; G01M 13/045; H02K 35/02; H01Q 1/22; H01Q 19/175; B65G 2203/0291; B65G 2203/0266; B65G 2203/043; B65G 2203/045

(57) ABSTRACT

A sensor assembly has a housing for mounting on a shaft of an idler roller in a belt conveyor system. The housing has one or more sensors for detecting one or more parameters of the idler roller and a processor in communication with the sensors and a wireless communication device. The sensors transmit the detected parameter data to the processor, which causes the detected parameter data to be transmitted by the wireless communication device. A monitoring system is also provided.

### TECHNICAL FIELD

The present invention relates to a sensor assembly and monitoring system for an idler roller in a belt conveyor system and in particular to a retrofittable sensor assembly for obtaining operational data relating to an idler roller of a belt conveyor system.

### BACKGROUND

A breakdown of a belt conveyor system for handling bulk material can be a serious problem. Each minute that the conveyor belt is out of operation can represent substantial economic losses. One particular component of the belt conveyor system which is regularly monitored to avoid unexpected shut down includes the rolling element bearings of the idler rollers.

For many conveyor operations there are two primary modes of failure; firstly, high bearing temperature is a significant indicator of imminent idler roller ball bearing failure; secondly, thinning of the idler roller's shell can lead to shell collapse and tearing of the conveyor belt. A common method for monitoring idler roller ball bearing temperature in bulk handling conveyors uses hand-held non-contact thermometers. However, this is extremely time consuming and involves manual input.

An alternative approach to monitoring the idler roller ball bearings is to embed sensors in the conveyor belt to sense the idler roller casing. This approach is disadvantageous as it requires substantial and uncertain modelling of the thermal transfer of the ball bearing to idler roller casing and then idler roller casing to the conveyor belt. This requirement to model numerous belt conveyor system parameters naturally leads to inaccurate monitoring of the wear of idler rollers.

Therefore, there is a need to alleviate one or more of the abovementioned problems or provide a useful alternative.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

Accordingly, a first aspect of the present invention provides a sensor assembly for an idler roller in a belt conveyor system, comprising:
a housing for mounting on a shaft of the idler roller, wherein the housing has:
   one or more sensors for detecting one or more parameters of the idler roller;
   a wireless communication device; and
   a processor in communication with the one or more sensors and the wireless communication device; wherein
the one or more sensors transmit the detected parameter data to the processor; and
the processer causes the detected parameter data to be transmitted by the wireless communication device.

In some embodiments, the sensor assembly comprises one or more seals to protect the one or more sensors, wireless communication device and processor from contaminants.

In some embodiments, sensor assembly is mounted to a mechanical seal of the idler roller. In other embodiments, the mechanical seal comprises a labyrinth seal.

In some embodiments, the one or more sensors perform one or more measurements of the parameters of the idler roller.

In some embodiments, the housing is substantially annular in shape or has a ring-shape to define a central opening through which to receive the shaft of the idler roller.

In some embodiments, the housing comprises a substrate onto which is mounted the processor. In other embodiments, the one or more sensors are mounted on the substrate. In a further embodiment, the wireless communication device is mounted on the substrate.

In some embodiments, the substrate comprises a circuit board for the processor. In other embodiments, the substrate conforms to the shape of the housing. In a further embodiment, the substrate is substantially annular in shape or ring shaped.

In some embodiments, the one or more sensors comprise one or more of: a temperature sensor, a rotation counter, a rotational velocity sensor, a vibration sensor, an accelerometer and an acoustic sensor.

In some embodiments, the one or more sensors comprise a temperature sensor for obtaining a temperature measurement indicative of the temperature of the idler roller. In one preferred embodiment, the temperature measurement is indicative of the temperature of a bearing of the idler roller. In other embodiments, the temperature sensor comprises a temperature probe. In further embodiments, a thermal transfer element is provided between the temperature sensor and the bearing. In one preferred embodiment, the thermal transfer element is a thermal washer.

In some embodiments, the one or more sensors comprise a rotation counter for measuring the rotations of a bearing of the idler roller. In further embodiments, the rotation counter comprises a magnetic based rotation counter. In other embodiments, the rotation counter comprises one or more magnetically responsive elements operatively connected to two or more magnets. In one embodiment, the two or more magnets are mounted to a magnet holder, and preferably the magnet holder is substantially annular in shape or ring shaped. In another embodiment, the magnet holder is affixed to one side of a seal of the sensor assembly. In yet another embodiment, the one or more magnetically responsive elements comprise magnetically responsive coils, which are preferably mounted to a substrate of the sensor assembly. In yet further embodiments, the one or more magnetic responsive coils detect the rotation of the two or more magnets. A further embodiment, the rotational velocity of the idler roller is calculated from the detected rotation of the two or more magnets.

In another embodiment, the one or more sensors comprise an accelerometer for measuring acceleration of the idler roller in one or more axes. For example, one axis may be coincident with or parallel to the longitudinal axis of the idler roller. In another example, one of the axes may be a reference axis, in the horizontal or vertical plane. From this measurement, low frequency vibrations experienced by the idler roller can be calculated. In yet another embodiment, the one or more sensors comprise an acoustic sensor for measuring acoustic data relating to the idler roller. From this measurement, low and high frequency vibrations experienced by the idler roller can be calculated. In yet further embodiments, the one or more sensors comprise a vibration sensor measuring vibrations experienced by the idler roller. From this measurement, low and high frequency vibrations experienced by the idler roller can also be calculated.

In certain embodiments, the sensor assembly comprises an energy harvesting mechanism for converting rotational movement of the sensor assembly into electrical energy to charge and/or recharge an energy storage device. Preferably, the energy storage device comprises a battery or a super-capacitor.

In certain embodiments, the energy harvesting mechanism comprises a plurality of permanent magnets operatively coupled to one or more energy harvesting coils for converting rotational movement of the permanent magnets into electrical energy. In further embodiments, the one or more energy harvesting coils count the rotation of the permanent magnets and passes this information (being the rotation count data) to the processor. In some embodiments, the rotational velocity of the idler roller is calculated from the measured rotation by the one or more energy harvesting coils.

In certain embodiments, the rotational velocity of the idler roller is compared to the rotational velocity of one or more idler rollers in the belt conveyor system to determine the relative shell thickness of the idler roller. Preferably, the rotational velocity of the idler roller is compared to the rotational velocity of an adjacent idler roller to determine the relative shell thickness of the idler roller.

In certain embodiments, the absolute shell thickness is calculated from the rotational velocity of the idler roller and the external shell radius. In other embodiments, the external radius of the idler roller is determined by comparing the belt speed of a conveyor belt with the rotational velocity of the idler roller.

In one embodiment, the sensor assembly is located adjacent an outer face of a labyrinth seal of the idler roller. In some embodiments, the outer face of the labyrinth seal is a “dirty” side of the labyrinth seal. Where the sensor assembly comprises a temperature sensor, the temperature sensor extends from a bearing of the idler roller through a stationary portion of the labyrinth seal.

In another embodiment, the sensor assembly is located adjacent an inner face of a labyrinth seal of the idler roller. In these embodiments, the inner face of the labyrinth seal is a “clean” side of the labyrinth seal. Where the sensor assembly comprises a temperature sensor, the temperature sensor is located adjacent to the bearing of the idler roller.

In some embodiments, the processor comprises a microprocessor or microcontroller.

In some embodiments, the detected parameter data comprises measurements of the parameters of the idler roller.

In some embodiments, the parameters of the idler roller comprise the bearing temperature, the number of rotations, the rotational velocity and vibrations relating to the idler roller.

In some embodiments, the wireless communication device broadcasts the detected parameter data. In other embodiments, the wireless communication device comprises a transceiver, radio transmitter or receiver. In further embodiments, the wireless communication device comprises an antenna.

In some embodiments, the wireless communication device comprises a transceiver in communication with an antenna assembly extending outside of the housing. Preferably, the antenna assembly comprises a plurality of antenna arrays. In some embodiments, each antenna array comprises a plurality of antennae. In some embodiments, at least one antenna is configured to extend parallel to the shaft of the idler roller. In other embodiments, the plurality of antennae is configured to extend parallel to the shaft of the idler roller

In some embodiments, the antenna assembly is arranged on an inner side of the idler roller. In some embodiments, the antenna assembly is arranged on an inner face of a labyrinth seal mounted to the idler roller. In other embodiments, the antenna assembly is arranged on an outer side of the idler roller. In further embodiments, the antenna assembly is arranged on an outer face of a labyrinth seal mounted to the idler roller.

In some embodiments, there are four antenna arrays. Preferably, the four antenna arrays are arranged in quadrature around the shaft of the idler roller.

In some embodiments, each antenna array comprises at least a director element, a driven element and a reflector element. In some embodiments, the antenna arrays share a common reflector element. Preferably, the common reflector element is cylindrical in shape. In some embodiments, the common reflector element is configured to extend parallel to the shaft of the idler roller.

In some embodiments, the sensor assembly comprises a transponder. Preferably, the sensor assembly comprises a fully encapsulated transponder.

In some embodiments, the transponder may have a temperature sensor, accelerometer, vibration sensor, rotation counter, radio transmitter/transceiver, microprocessor, antenna, power source (typically battery and/or power harvesting converting idler roller rotation into energy) and a modified bearing labyrinth seal.

In some embodiments, there is provided a transponder for relaying sensor data related to an idler roller of a belt conveyor system, wherein the transponder is mountable to a labyrinth seal of the idler roller. The transponder comprises a wireless communication device and one or more sensors, like a temperature sensor and/or a rotation sensor, coupled to a microcontroller configured to obtain, via the one or more sensors, parameters related to the idler roller, such as a temperature measurement indicative of the temperature and rotations of a bearing of the idler roller, and broadcast, via the wireless communication device, sensor data indicative of the temperature and/or rotations of the bearing.

A second aspect of the present invention provides a telemetry-enabled seal assembly for an idler roller in a belt conveyor system, comprising:
a mechanical seal for mounting on a shaft of the idler roller;
a housing connected to the mechanical seal, wherein the housing has:
   one or more sensors for detecting one or more parameters of the idler roller;
   a wireless communication device; and
   a processor in communication with the one or more sensors and the wireless communication device;
   wherein the one or more sensors transmit the detected parameter data to the processor; and
   the processer causes the detected parameter data to be transmitted by the wireless communication device.

Preferably, the one or more sensors comprise one or more of a temperature sensor for measuring the temperature of a bearing of the idler roller, a rotation counter for measuring the rotations of the bearing of the idler roller, a rotational velocity sensor for measuring the rotational velocity of the idler roller, a vibration sensor for measuring vibrations experienced by the idler roller, an accelerometer for measuring the acceleration of the idler roller and an acoustic sensor for measuring acoustic data relating to the idler roller.

The second aspect of the present invention may have one or more of the preferred features of the above embodiments of the first aspect. For example, in some embodiments, the rotation counter comprises one or more magnetically responsive elements and two or more magnets, the magnets being mounted to a magnet holder, wherein the one or more magnetically responsive elements are mounted on the housing and the magnet holder is mounted on a side of the mechanical seal opposite to the side of the mechanical seal connected to the housing.

In some embodiments, the mechanical seal is a labyrinth seal, the housing being connected to an inner face of the labyrinth seal. Where the wireless communication device comprises an antenna assembly, the antenna assembly may be arranged on the same side inner side of the labyrinth seal; that is, on an inner side of the idler roller shaft. In other embodiments, the mechanical seal is a labyrinth seal, the housing being connected to an outer face of the labyrinth seal.

A third aspect of the present invention provides a monitoring system for one or more idler rollers in a belt conveyor system, comprising:
a sensor assembly according to the first aspect of the invention or a telemetry-enabled seal assembly according to the second aspect of the invention mounted to the one or more idler rollers;
a receiver for receiving the detected parameter data from the wireless communication device; and
a central processing unit in communication with the receiver for analysing the detected parameter data.

In some embodiments, the central processing unit is configured to compare the detected parameter data against one or more predetermined data thresholds; and in response to one of the detected parameter data passing one of the predetermined data thresholds, transmit a signal to alert replacement and/or repair of the idler roller associated with the one of the detected parameter data passing one of the predetermined data thresholds. In other embodiments, the central processing unit executes diagnostic processing software to analyse the detected parameter data.

In some embodiments, the central processing unit is configured to receive parameter data from one or more of the sensor assemblies at regular intervals. Alternatively, the central processing unit transmits a command to one or more of the sensor assemblies to report the detected parameter data in reply to the command.

In some embodiments, the receiver is physically remote to the sensor and/or idler roller. In further embodiments, the receiver is located in a communications hub for receiving detected parameter data from a plurality of sensors.

In some embodiments, the central processing unit is located in the communications hub.

In some embodiments, the receiver comprises a transceiver and transmits commands from the central processing unit to the wireless communication device of the sensor assembly.

In some embodiments, there is a plurality of receivers, each connected to different sensor assemblies located in different idler rollers, wherein the central processing unit is communication with the plurality of receivers.

In a fourth aspect there is provided a belt conveyor system comprising a plurality of idler rollers, a plurality of sensor assemblies according to the first aspect or a plurality of telemetry-enabled seal assemblies according to the second aspect and the monitoring system according to the third aspect, wherein there is a plurality of receivers in communication with the central processing unit, each connected to different sensor assemblies or telemetry-enabled seal assemblies located in different idler rollers.

In a fifth aspect there is provided a method of installing the sensor assembly according to the first aspect to an idler roller, comprising:
removing an end cap from the idler roller;
mounting the sensor assembly on a shaft of the idler roller;
replacing the end cap on the idler roller; and
communicating with the wireless communication device in the sensor assembly.

In some embodiments, the method further comprises removing a mechanical seal from the idler roller and connecting the sensor assembly to the mechanical seal. In further embodiments, the connected sensor assembly and mechanical seal are mounted to the idler roller shaft.

In some embodiments, the method further comprises placing a dust cover over the sensor assembly after mounting to the idler roller shaft.

In some embodiments, the sensor assembly comprises a rotation counter and energy harvesting mechanism in the form of one or more magnetically responsive elements mounted to a substrate of the sensor assembly and operatively connected to two or more magnets mounted to a magnet holder, and the method further comprises mounting the substrate on one side of the mechanical seal and the magnet holder to an opposite side of the mechanical seal. In other embodiments, the mechanical seal comprises a labyrinth seal.

In some embodiments, the method further comprises connecting the wireless communication device to a receiver for communicating with a central processing unit, wherein the central processing unit analyses the detected parameter data. In other embodiments, the receiver comprises a data link and the central processing unit executes diagnostic processing software to analyse the detected parameter data.

In some embodiments, the method further comprises replacing a mechanical seal in the idler roller with the sensor assembly. In certain embodiments, the mechanical seal is a labyrinth seal of the idler roller.

In a sixth aspect there is provided a kit for installing the sensor assembly according to the first aspect to an idler roller, comprising:
the sensor assembly according to the first aspect; and
a plurality of labyrinth seal components, wherein at least two pairs of labyrinth seal components are of differing sizes.

In some embodiments, the kit comprises replacing a plurality of dust covers, wherein at least two dust covers are of differing sizes. In other embodiments, the kit further comprises a plurality of fasteners and/or an adhesive.

Throughout the description and the claims, the words “comprise”, “comprising”, and the like are to be construed in an inclusive sense as opposed to an exclusive or exhaustive sense; that is to say, in the sense of “including, but not limited to”.

### BRIEF DESCRIPTION OF THE FIGURES

Preferred embodiments of the invention will now be described, by way of example only, with reference to the accompanying figures, in which:

FIG. 1 is a cross-sectional view of a belt conveyor system comprising an idler roller and a pair of sensor assemblies according to a preferred embodiment of the invention;

FIG. 1B is a magnified cross-sectional view of circle B in FIG. 1 illustrating one end of the idler roller and the sensor assembly;

FIG. 2 is a magnified cross-sectional view of circle B in FIG. 1 omitting environmental details to illustrate the internal components of the sensor assembly;

FIG. 3 is an end view of the components of the sensor assembly of FIGS. 1B and 2;

FIG. 4A is a functional block diagram representing one embodiment of the components of the sensor assembly of FIGS. 1B and 2;

FIG. 4B is a functional block diagram representing another embodiment of the components of the sensor assembly of FIGS. 1B and 2;

FIG. 4C is a functional block diagram representing a further embodiment of the components of the sensor assembly of FIGS. 1B and 2;

FIG. 5 is a block diagram representing a monitoring system comprising a plurality of sensor assemblies of FIGS. 1B and 2;

FIG. 6A illustrates an end view of the sensor assembly mounted to the idler roller of FIGS. 1B and 2;

FIG. 6B illustrates an exploded end view of the sensor assembly of FIG. 6A;

FIG. 7 is a flow chart representing an exemplary method for a retrofitting the sensor assembly of FIGS. 1B and 2 to an idler roller;

FIG. 8 is a cross-sectional view of one end of the idler roller and a sensor assembly according to a further embodiment of the present invention, where the sensor assembly is located on an inner side of the bearing;

FIG. 9A is a perspective view of an antenna assembly used in the sensor assembly of FIG. 8;

FIG. 9B is a perspective view of an alternative embodiment of an antenna assembly for use in the sensor assembly of FIG. 8; and

FIG. 9C is an azimuth gain plot of the antenna assembly of FIG. 9A.

### DETAILED DESCRIPTION OF THE PREFERRED EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

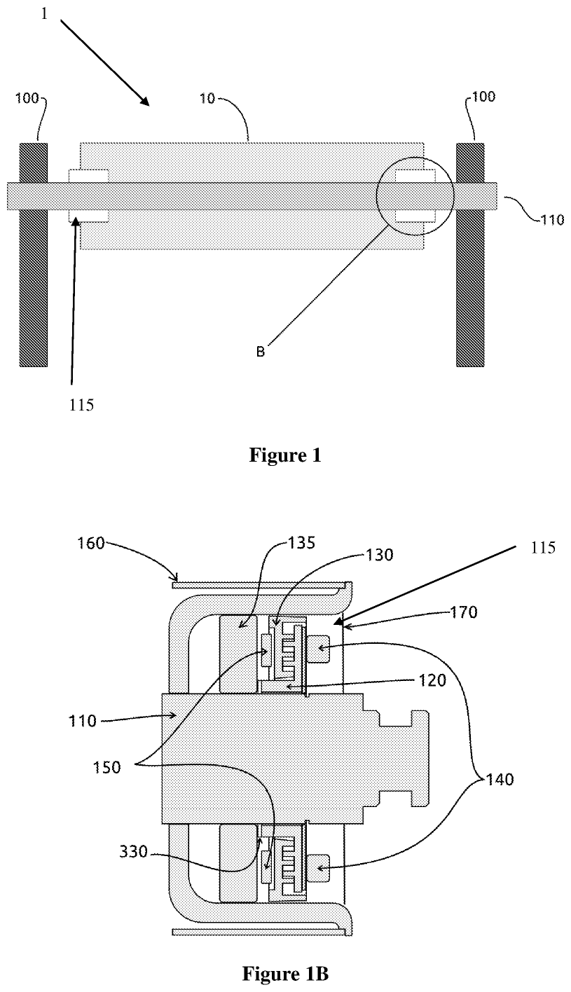

Referring to FIG. 1 there is shown a belt conveyor system 1 having a plurality of conveyor idler rollers 10 for supporting a conveyor belt (not shown), each idler roller being supported by an idler shaft 110 mounted on support brackets 100. The idler rollers 10 each have a sensor assembly in the form of transponder 115 according to an embodiment of the present invention mounted on each end of the idler roller.

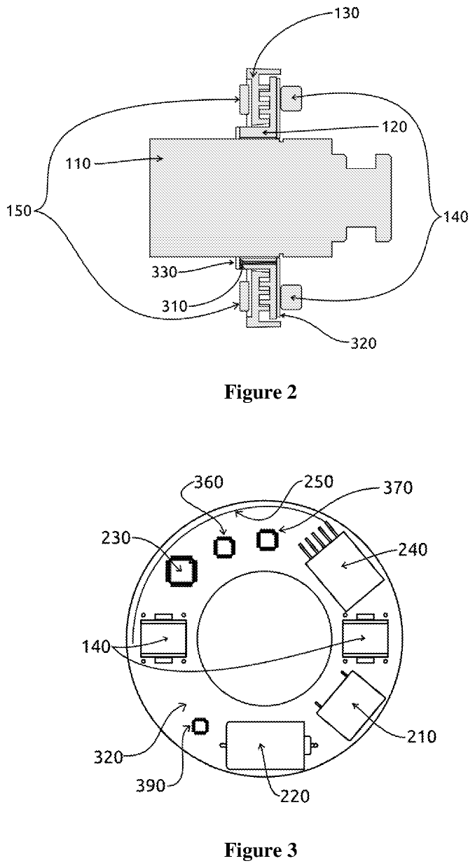

Referring to FIGS. 1B and 2, the transponder 115 comprises a housing in the form of an annular or ring-shaped body 320 that can be mounted to the shaft 110 of the idler roller 10. The transponder also comprises sensors 140, 150, 310, 360, 270, 390 for detecting parameters or characteristics of the idler roller, a processor in the form of a microcontroller 230 and a wireless communication device in the form of a transceiver 240 and antenna 250, as best shown in FIG. 3. The parameters or characteristics of the idler roller 10 relate to operational or physical aspects of the idler roller 10, such as, but not limited to, temperature of the bearings 135, rotational speed of the idler roller, shell thickness of the idler roller, vibrations experienced by the idler roller, number of rotations of the idler roller and ambient noise. In this embodiment, the transponder 115 may also comprise a labyrinth seal formed by seal halves 120 and 130, to which is mounted the body 320. However, in other embodiments, the sensor assembly or transponder 115 may be installed within an existing mechanical seal, and so may not require its own seal.

The transponder 115 has two sensors in the form of a temperature sensor 310 (as best shown in FIG. 2) and a rotation sensor 140, 150 (as best shown in FIG. 1B). The temperature sensor 310 is in the form of a temperature probe that extends from the body 320 to be within close proximity or adjacent to the bearing 135 of the idler roller 10. This results in a highly accurate temperature measurement of the bearing 135 being obtained. To accommodate any small gaps between the temperature prober 310 and the bearing 135, a thermal washer 330 may be used to assist in thermal transfer from the bearing 135 to the temperature probe 310.

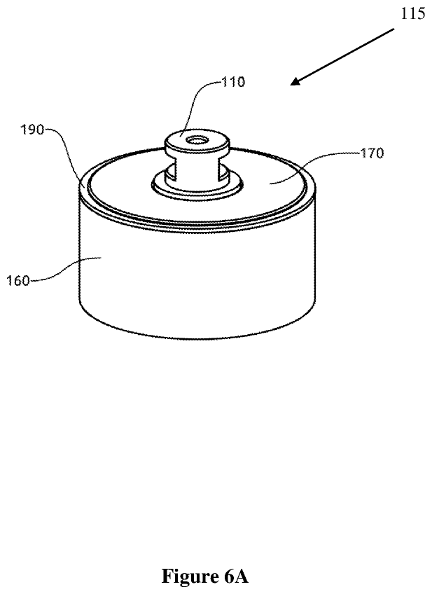

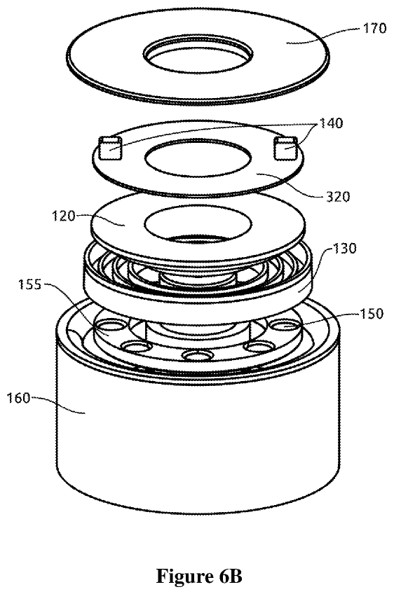

The rotation sensor 140, 150 comprises magnetically responsive elements in the form of energy harvesting coils 140 and a plurality of permanent magnets 150 mounted to a magnet boss 155, as best shown in FIG. 6B. The energy harvesting coils 140 count how many times the permanent magnets 150 pass the energy harvesting coils 140. This count provides an accurate measure of the number of rotations of the idler roller 10 as well as the rotational velocity of the idler roller. The number of counts per revolution is dependent on the particular configuration of the energy harvesting coils 140 and the permanent magnets 150.

As the shell 160 of the idler roller 135 begins to wear, its rotational velocity will increase for a given linear velocity (i.e. the speed) of the conveyor belt. By comparing the rotational velocity of the idler roller with the linear velocity or belt speed of the conveyor belt, shell thickness of the idler roller can be calculated by the following relationship:

$$Shell Thickness = 1000 \times ( \frac{Belt Speed - Inner Diameter}{Π \times RPM} )$$

Where: Shell Thickness is in millimetres
Inner Diameter of shell is in metres
Belt Speed is linear speed in metres/minute
RPM is rotational speed of idler roller in Revolutions Per Minute
π is the ratio of a circle's circumference to its diameter

In one example, the belt speed is measured by using an auxiliary idler roller in the return path of the conveyor belt. Alternatively, the belt speed may be obtained from the head-end drive pulley speed.

Referring to FIG. 3, the transponder body 320 comprises a substrate in the form of a printed circuit board onto which is mounted several electronic components, including a super-capacitor 210, a battery 220, the microcontroller 230, the transceiver 240 and an antenna 250. The battery 220 provides energy to power the microprocessor 230 and transceiver 240 whilst the idler roller 10 is laying idle. Additionally, the super-capacitor 210 assists in meeting the short-term energy demand of the transceiver 240. The energy-harvesting coils 140 also provide the electrical current required to keep the super-capacitor 210 charged whilst the idler roller 10 is in motion. This electrical current is induced in the energy-harvesting coils 140 as the permanent magnets 150 rotate past. When the idler roller 10 is rotating at a sufficient velocity, the steady-state energy requirements of the transceiver 240 are satisfied by the charge held in the super-capacitor 210. However, if the rotational velocity of the idler roller 10 is insufficient, then the steady-state energy requirements of the transponder 320 are met by the battery 220.

The printed circuit board also has sensors mounted thereon, including an accelerometer 360, vibration sensor 370 and acoustic sensor 390. The accelerometer 360 measures the acceleration of the idler roller 10 and hence the low frequency vibrations being experienced by the idler roller 10. Similarly, the vibration sensor 370 and acoustic sensor 390 also measure low and high frequency vibrations, the acoustic sensor 390 indirectly by way of measuring acoustic data. These vibration measurements can be an early warning sign of an upcoming fault in the bearing 135 of the idler roller 10.

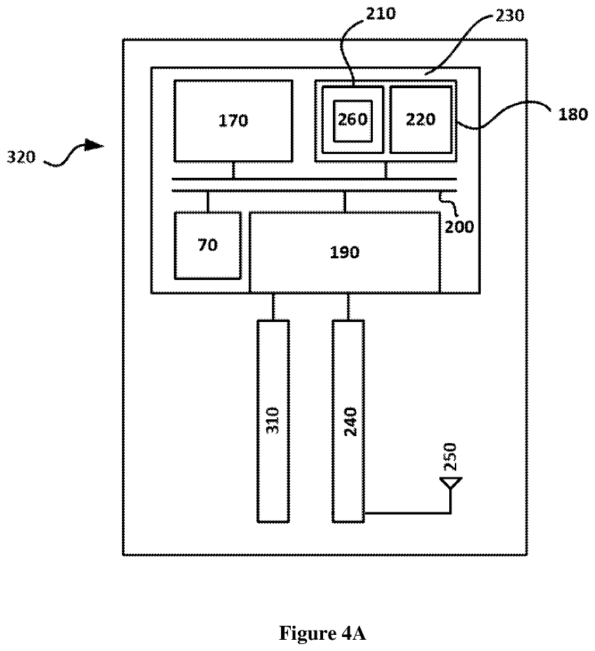

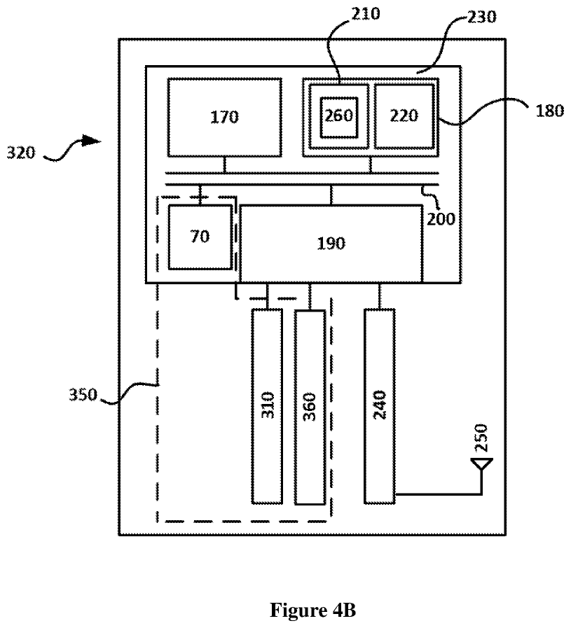

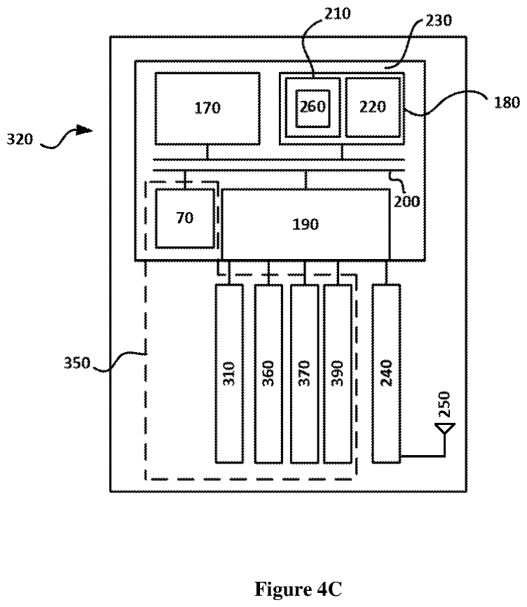

As shown in FIG. 4A, the microcontroller 230 of the transponder body 320 comprises a processor 170, a memory 180, and an input/output interface 190 coupled together via a bus 200. The memory 180 comprises both a non-volatile memory 210 and volatile memory 220. The non-volatile memory 210 can store a computer program embodied in the form of executable instructions 260 for executing commands and generating sensor data 460 based on the sensor measurements received from the one or more sensors 140, 150, 310, 360, 370, 390. The transponder 320 periodically broadcasts the sensed data via the transceiver 240, which in other embodiments may be a radio transmitter. The electrical signals from transceiver 240 are converted into electromagnetic waves via the antenna 250.

The microcontroller 230 also has an integrated internal temperature sensor 70. However, in other embodiments, the temperature sensor 70 may be replaced with the temperature probe 310, which is coupled to the microcontroller 230 via the input/output interface 190. The temperature probe 310 can be utilised in situations where substantially direct or near-direct temperature sensing of the bearing 135 of the idler roller 10 is possible or required.

Referring to FIG. 4B, another embodiment of the transponder body 320 is illustrated, where the accelerometer 360 is coupled to or integrated with the microcontroller 230. In this configuration, at least some of the sensor data 460 generated by the microcontroller 230 is indicative of vibration data, preferably low-frequency vibration data. The transponder 115 may only generate sensor data 460 indicative of the vibration data, preferably low-frequency vibration data, in response to receiving an external request to provide acceleration data. Alternatively or additionally, the transponder 115 periodically broadcasts acceleration data via the transceiver 240 and antenna 250.

Referring to FIG. 4C, a further embodiment of the transponder body 320 is illustrated, where the vibration sensor 370 and acoustic sensor 390 are coupled to or integrated with the microcontroller 230. As described above, the transponder 115 periodically generates sensor data indicative of the vibration and/or acoustic data or only in response to an external request communicated to the transponder. In either case, the vibration and/or acoustic data is transmitted or broadcast data via the transceiver 240 and antenna 250.

In some exemplary configurations, a series of discrete sensor measurements can be obtained over a period of time by the transponder 115 and transmitted or reported by the transceiver 240. In particular, a request can be made to the transponder 115, wherein the command includes a request for a series of discrete sensor measurements for a predetermined period of time. For example, the series of discrete sensor measurements may be obtained every minute for a one-hour period. The command may also be a request that a selection of the one or more sensors to generate the series of discrete sensor measurements. For example, a request may be sent to the transponder 115 that only the temperature sensor 310 and the accelerometer 360 provide discrete sensor measurements, whereas the other sensors may remain idle, report at different frequencies or time periods, or only in response to a threshold measurement value. For example, if the temperature sensor 310 measures a threshold value of above the bearing's recommended operating temperature that indicates that imminent failure is likely, the microcontroller 230 will automatically report this measured value via the transceiver 240 without requiring a request.

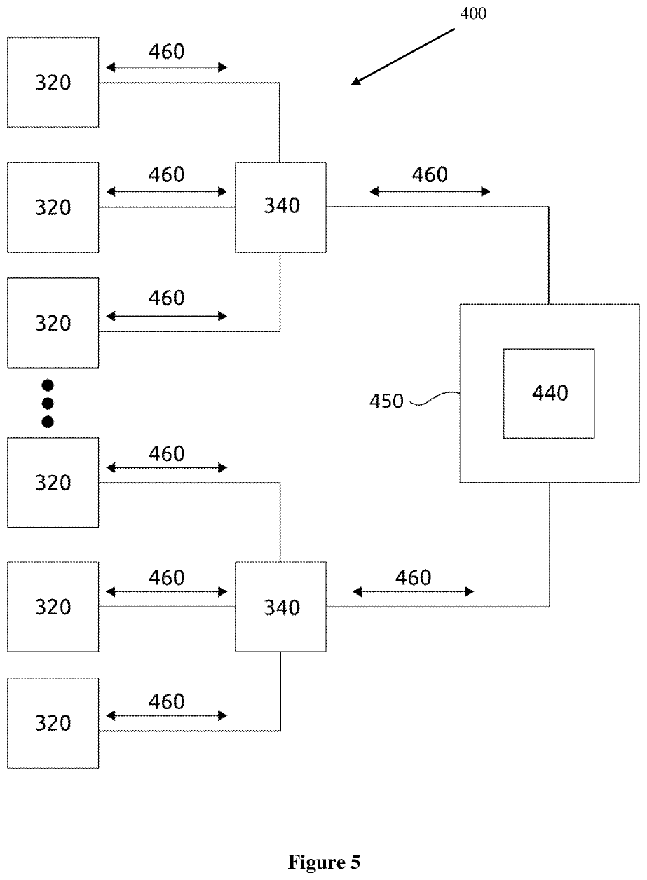

As shown in FIG. 5, a monitoring system 400 according to one embodiment of the invention is illustrated, where there is plurality of sensor assemblies 115 mounted to a corresponding plurality of idler rollers 10. The microcontroller 230 mounted on the substrate of each sensor assembly 115 is configured to broadcast detected or measured sensor data 460 from one or more of the sensors 140, 150, 310, 360, 370, 290 via a second wireless communication device 340, which is in the form of a hub or local network. This hub 340 then sends the sensor data 460 to a diagnostic processing system 450 executing diagnostic software 440. The second wireless communications device 340 thus acts as a data concentrator. These hubs 340 are located at regular intervals along the length of the conveyor belt system, can be spaced anywhere from several metres to several kilometres, if required. To assist avoid multipath destructive interference from multiple signals, in a further embodiment a diversity-based hub can be employed. This hub would include two (2) separate antennae, which are selectively used based on signal strength. That is, the antenna having the strongest signal strength would be selected and used by the hub to receive and transmit data. Alternatively, in other embodiments of the monitoring system, the individual transceivers 240 of each sensor assembly 115 broadcasts the sensor data 460, which is directly received from the diagnostic system 450 wirelessly.

Referring to FIGS. 6A and 6B, there is shown an example of a sensor assembly or transponder 115 mounted to the shaft 110 of the idler roller 10 within its shell 160. The transponder 115 is embodied in a ring-shaped printed circuit board 320, and mounted to a labyrinth seal assembly 120, 130. Essentially, the labyrinth seal assembly 120, 130 is telemetry enabled by incorporating the transponder 115. In this way, the telemetry-enabled labyrinth seal assembly 120, 130 can be used as an installed component into an idler roller 10 or a direct replacement for an existing labyrinth seal in an idler roller 10 in a pre-existing conveyor system. It will be appreciated that the transponder 115 can be incorporated into any type of mechanical seal used with an idler roller and is not limited to a labyrinth seal.

Where the transponder 115 is incorporated into a telemetry-enabled labyrinth seal assembly, it may be mounted on the “dirty” side (i.e. externally, outwardly or outer facing side relative to the idler roller 10 and conveyor) of the labyrinth seal, being outer seal component 120. The whole assembly is protected by a dustcover 170 and optionally some form of encapsulant or conformal coating. The ring-shaped body of the printed circuit board 320 comprises an opening or hole through which the shaft 110 of the idler roller 10 is received. Alternatively, the printed circuit board 320 is mounted to the “clean” side (i.e. an inwardly or inner side relative to the idler roller 10 and conveyor) of the labyrinth seal, being inner seal component 130. Irrespective of whether the printed circuit board 320 is located adjacent the clean or dirty side of the labyrinth seal 120, 130, it is a requirement that the permanent magnet retaining boss 155 be located on the opposite side of the labyrinth seal (i.e. adjacent the other seal component) to the printed circuit board 320 in this particular embodiment that uses the coils 140 for energy harvesting. In this way, the permanent magnets 150 will pass the energy harvesting coils 140 when the idler roller 10 rotates.

In the case of the transponder 115 being mounted on the clean side of the labyrinth seal 120, 130, the antenna 250 will be subject to constant rotation due to rotation of the idler rollers 10 whilst the conveyor is in use. A particular challenge to the reliable broadcast of the transponder data 460 is the inherent phase, amplitude and frequency modulation caused by the influence of the tumbling antenna 250 as the roller 10 rotates in operation. Due to the relative velocity of the antenna 250 being slow (compared to the speed of light, c) very little frequency modulation occurs. However, careful choice needs to be exercised over the antenna design to avoid amplitude and phase modulation. The influence of antenna gain ripple due to a non-flat antenna response (caused by rotation) can reduce sensitivity of the transceiver 240. However, a phase shift due to an incorrectly oriented antenna 250 within the transponder 115 can lead to an inability of the transceiver 240 to decode sensor data 460.

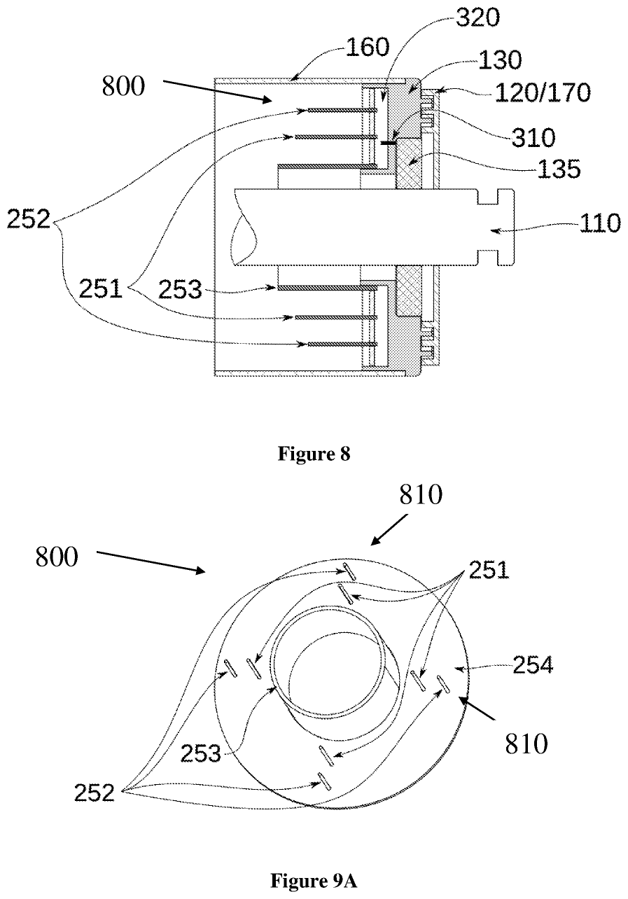

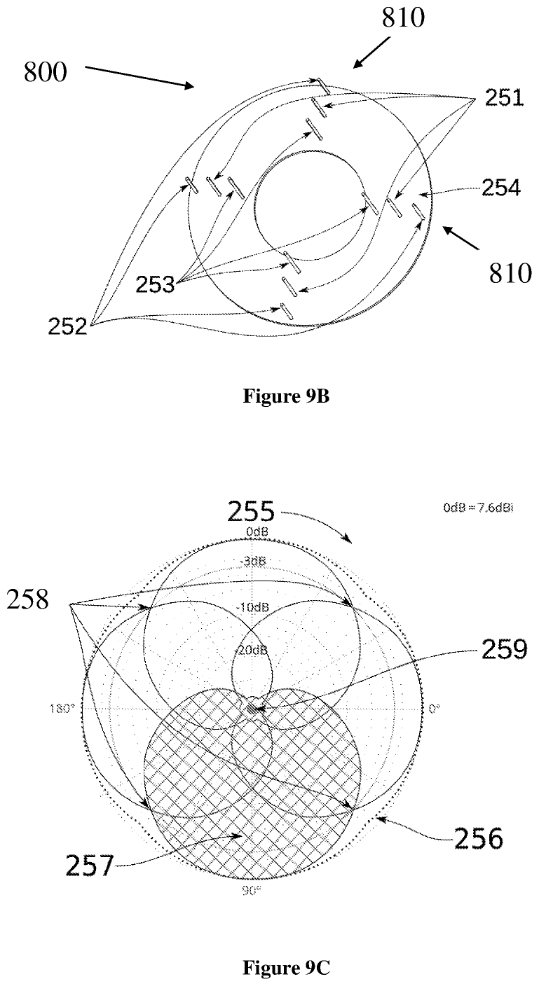

To avoid these deleterious effects, an antenna assembly 800, which the inventors have called a “rolling antenna” or “rolling antenna assembly”, has been developed for the transponder 115, as best shown in FIGS. 8 and 9A. The rolling antenna 800 is configured to provide consistent radio field strength between the roller telemetry and the hub 340. This antenna assembly 800 includes a four-part compound antenna assembly, which is formed by antenna arrays 810 of 3-element Yagi-like antennae 251, 252, 253. That is, each antenna array 810 comprises a driven element 251, a director element 252 and a reflector element 253 (which is shared by all the antenna arrays 810). Yagi antennas, named after Hidetsugu Yagi, are well known and described, for example, in Japanese Patent No. 69115. The four antenna arrays 810 are mounted in quadrature, having the common reflector element 253.

As the conveyor idler roller 10 rotates, each 3-element Yagi-like array 810 sweeps past the direction of the receiver antenna (that is, the hub 340 or similar access point). During this rotation, there is not any “flipping” of elements 251, 252 in this configuration (that would otherwise cause a 180° phase shift), but only a small phase shift due to the differential path length of each Yagi-like antenna array or subassembly 810.

FIG. 9C is an azimuth gain plot of the rolling antennae 251, 252. The centre of the plot 259 represents the location and orientation of the shaft 110 through the quadrature array of the 3-element Yagi-like arrays 810. The response of a single Yagi-like array 810 is defined by the region 257. This is rotated through 90° around the shaft 110.

It should be noted that the −3 dB (half-power) 256 line cuts through each respective antenna pattern or region 257 at approximately ±45° on either side of the main lobe at points 258, thus ensuring close to unity (relative) gain throughout all angles of rotation. The inventors contemplate that using only two antenna arrays or three antenna arrays in the sensory assembly 800 do not provide a sufficiently constant amplitude through rotation. Whilst more antennae can be added to each antenna array, this increases the risk of destructive interference occurring with such higher gain arrays. Also, these higher gain arrays can only be applied in very wide diameter idler rollers or at very short wavelengths, limiting their application in industrial environments. Consequently, four antenna arrays 810 are preferred for the antenna assembly 800.

In one example, the operating frequency of a system using a transponder 115 with a rolling antenna assembly 810 is predominantly the 900 MHz, 2.4 GHz and 5.0 GHz ISM (Industrial Scientific Medical) class free bands. Also, the typical mining conveyor roller diameter varies from around 100 mm to 200 mm. It is therefore possible to improve isotropic radiation by adding more elements to the Yagi-like antenna arrays 810. However, this will narrow the forward lobe, requiring more antenna arrays and so adding substantial width to the roller 10 to maintain a low amplitude ripple during rolling. Also, fringing effects between the driven and passive elements on adjacent arrays 810 lead to low-gains being achieved by each independent Yagi-like array 810.

The lengths of the Yagi antenna elements, being the director 252, reflector 253 and driven element 251 can be readily determined, based on operational requirements and location factors. The antenna element lengths and spacings will also be influenced by various fringing effects, most notably the small distance between the director 252 and a thick polymer roller shell 160 (which may only be millimetres). An example of suitable lengths and spacings for the antenna elements is shown in Table 1 below.

TABLE 1
Element lengths and spacings

| | | |
|---|---|---|
| Director length | 0.22 | λ |
| Reflector length | 0.25 | λ |
| Driven Element length | 0.24 | λ |
| Director to Driven Element spacing | 0.125 | λ |
| Reflector to Driven Element spacing | 0.125 | λ |

Where: λ=C (speed of light)/frequency (cycles per second)

It should also be noted that these 3-element antenna arrays are not normal Yagi antennas as they are not driven by a dipole, but utilise ¼ wavelength (λ) monopole driven elements 251 which are connected to the transceiver 240 by equal length controlled-impedance traces and matching networks to ensure phase integrity. Likewise, the director element 252 and reflector element 253 are based on a ¼ wavelength monopole rather than a ½ wavelength dipole (as shown in Table 1 above). For this to be effectively achieved, a substantial area of the antenna array assembly 800 (the disk-shaped substrate 254) needs be a ground plane to meet the principle of “dipole ground symmetry”.

In the case of the preferred embodiment, the reflector 253 is formed by a conductive cylinder that surrounds the roller shaft 110. The purpose of this large reflector element 253 in FIG. 9A (which is common to or shared by all four Yagi-like antenna arrays 810) is to provide a known high conductivity reflector element, rather than relying on the less conductive steel roller shaft 110. Also, the larger diameter reflector 253 provides more effective shadowing of the opposing Yagi-like array(s) 810. This substantially attenuates the normal rear-lobe signal typically found in low-gain, low-element count, Yagi antennas, thus giving improved front-to-back gain.

An alternate embodiment is shown in FIG. 9B, in which the large cylindrical reflector 253 in FIG. 9A has been replaced with four individual reflector monopoles 900. This arrangement may provide some improvement over using the shaft 110 alone as a reflector, since the dimensions are more controllable and materials more conductive. However, it does not have the same rear lobe attenuation, which mostly affects amplitude ripple 256.

In either case, the antenna assemblies of FIGS. 9A and 9B may be used with the sensor assembly 115 mounted on the clean side of the idler roller 10, with the choice of antenna assembly dependent on operational or capital expenditure needs.

The antenna assembly 810 is thus is an “inboard” version of the sensor assembly 115, and is applicable to conveyor systems where insufficient room exist to locate the telemetry transponder 115 immediately adjacent to the bearing or when the roller shell 160 is fabricated a non-conductive material, such as a polymer. In this configuration, the transponder 115 incorporating the antenna assembly 810 is located on the proximal side of the housing of the bearing 135 adjacent the associated labyrinth seal.

It is intended that the telemetry-enabled labyrinth seal assembly incorporating the sensor assembly/transponder 115 be used by conveyor operators and manufacturers as a replacement for current labyrinth seals. The transponder body 320 can be affixed to either side of the labyrinth seal components 120, 130 by way of adhesive, a suitable fastener or clip detail. In the same way, the permanent magnet retaining boss 155 can be affixed to the opposite seal component of the labyrinth seal 120, 130 by way of adhesive, a fastener or clip detail. If there is a spatial constraint making it difficult to locate the transponder body 320 then an oversized retro-fit dust cover 170 can then be fitted over the transponder body 320 to protect the printed circuit board, sensors and electrical components, as shown in FIG. 6A. The dust cover 170 also comprises a central opening or hole to receive the shaft 110 of the idler roller 10. Whilst some additional space above the transponder body 320 can be made available by changing the shape of the dustcover 170, it is preferable that the dust cover avoid interfering with the idler roller bracket 100.

It will be appreciated that the sensor assembly 115 (either as part of a telemetry-enabled labyrinth seal assembly or as a modification to an existing labyrinth seal) can be installed at opposing ends of an idler roller 10 to obtain sensor data 460 for both bearings 135 at the opposing ends of the idler roller 10. As shown in FIG. 5, a plurality of transponders 115 with their transponder bodies 320 may be retrofitted to a plurality of idler rollers 10 in the conveyer belt system 1, and thus obtain sensor data for at least some or all idler rollers 10.

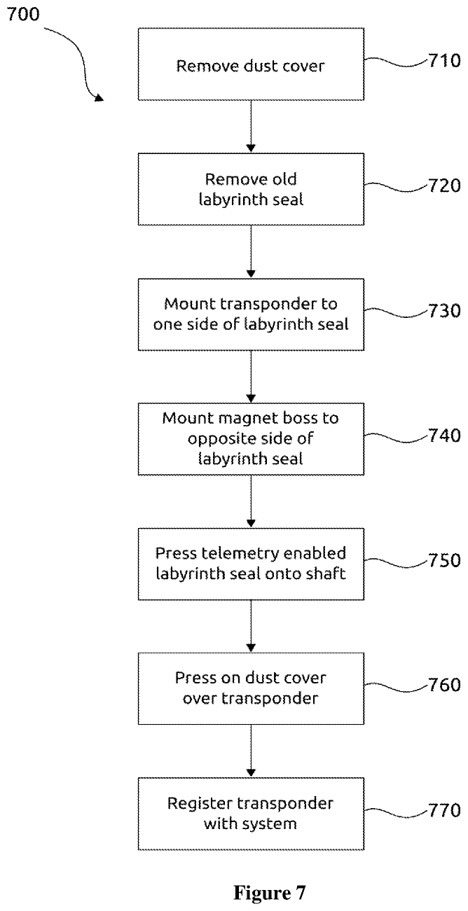

Referring to FIG. 7 there is shown a flow chart representing a method 700 for installing the sensor assembly 115 and monitoring system 400 for obtaining sensor data 460 to an idler roller 10 of the conveyor belt system 1. At step 710, a dustcover is removed from the idler roller 10, thereby exposing a pre-existing or “old” labyrinth seal 120, 130. At step 720, the labyrinth seal 120, 130 is removed from the idler roller 10. If the labyrinth seal 120, 130 is being replaced by a telemetry-enabled labyrinth seal assembly, then steps 730 and 740 may be skipped.

At step 730, the transponder 115 (including transponder body 320) is mounted to one side of the labyrinth seal 120, 130, either to the dirty side adjacent the labyrinth seal component 120 or the clean side adjacent the labyrinth seal component 130. The transponder 115 can be mounted using one or more fasteners, an adhesive or clip details moulded into labyrinth seal component 120 or 130. The choice of whether the transponder is to be located on the dirty-side of the seal 120 or the clean-side of the seal is generally based on where the greatest void or space exists to accommodate the transponder 115. That is, if there is more room between the dustcover 170 and the outer (dirty-side) half at the labyrinth seal component 120 then it is likely that the transponder 115 should operate on the dirty side of the seal. If, however, there is more room between the clean-side of the labyrinth seal and the ball bearing 135 then it is more likely that the transponder 115 should be mounted to the clean-side at the labyrinth seal component 130.

At step 740, the magnet boss 155 is mounted to the labyrinth seal 120, 130. The magnet boss 155 holds several permanent magnets that, together with energy harvesting coils 140, are used to form part of a magneto for energy harvesting. The number of permanent magnets 150 contained in the magnet boss 155 should ideally be an even number (i.e., 2, 4, 6, 8 etc.) and the polarity of these permanent magnets should preferably alternate so as to maximise the rate of change of magnetic flux seen by each energy harvesting coil 140 for a given rotational speed of the idler roll 10. It is preferable that the magnet boss 155 be mounted on the opposite side of the labyrinth seal 120, 130 to the transponder body 320 which contains the energy harvesting coils 140. For example, if the transponder body 320 is mounted to the dirty side adjacent the labyrinth seal component 120 then the magnet boss 155 is preferably mounted to the opposite clean side adjacent the labyrinth seal component 130.

Thus, the “old” labyrinth seal 120, 130 is now modified by installation of the sensor assembly 115 as a new telemetry-enabled labyrinth seal assembly. This new telemetry-enabled labyrinth seal assembly thus has the labyrinth seal (dirty externally facing side) component 120, labyrinth seal (clean-side) component 130, transponder body 320 (including the printed circuit board), sensors 140, 150, 310, 260, 270, 290 (including temperature sensor 310), magnet boss 155 and thermal washer 330 (if required). It is assumed that the labyrinth seal will be provided already packed with grease.

At step 750, the telemetry-enabled labyrinth seal assembly is then pressed into the shell 160 of the idler roller 10 around the shaft 110. At step 760, the dustcover 170 is pressed onto the idler roller shaft 110 over the transponder 115 which engages with the end cap engagement assembly of the idler 10. At step 770, the transponder 115 is activated to register the particular transponder onto the network, and hence monitoring system 400.

It will be appreciated that method 700 can be repeated for each end of the idler roller 10 so that both bearings 135 of the idler roller 10 can be monitored. It will also be appreciated that the method 700 can be repeated for multiple idler rollers 10 of the belt conveyor system 1. In this way, the telemetry-enabled labyrinth seal assembly can be retrofittably mounted to either end of a conveyor roll 10 in the field or during manufacture.

A kit can also be provided for retrofitting to any type of idler roller 10. In particular, the kit comprises the sensor assembly 115 and a plurality of labyrinth seals 120, 130 for mounting to different models or brands of idler rollers 10 that may have different sized labyrinth seals. Hence, an appropriately sized labyrinth seal 120, 130 can be selected by the installer from the kit for a specific type of idler roller 10. The kit may also comprise the dustcover 710. Additional components of the kit may comprise one or more fasteners and/or an adhesive to mount the transponder body to the selected labyrinth seal components 120, 130.

While the sensor assembly 115 has been described in relation to FIGS. 1 to 6B as being in the form of a transponder in the above embodiments, it will be appreciated that the sensor assembly can be embodied in other forms, such as a telemetry labyrinth seal unit that incorporates the labyrinth seal components 120, 130 as discussed in relation to FIG. 7 in the context of modifying pre-existing labyrinth seal to include the sensor assembly. Such a telemetry labyrinth seal unit may be provided where the unit is manufactured to incorporate the sensor assembly, instead of retrofitting to a pre-existing labyrinth seal.

It will further be appreciated that any of the features in the preferred embodiments of the invention can be combined together and are not necessarily applied in isolation from each other. For example, the different configurations for the transponder body described in relation to FIGS. 4A to 4C may be used with different sensor assemblies in the same monitoring system for a belt conveyor system. In addition, different sensor assemblies may have different combinations of sensors to monitor different parameters or characteristics of the idler rollers at different locations along the belt conveyor. Similar combinations of two or more features from the above described embodiments or preferred forms of the invention can be readily made by one skilled in the art.

From the above description of the preferred embodiments of the invention, it can be seen that the sensor assembly can be easily fitted and removed from an idler roller, as well as providing accurate measurements of a wide range of parameters or characteristics relating to an idler roller at regular intervals without requiring human involvement. Moreover, the sensor assembly is preferably designed to be incorporated into the modified bearing labyrinth seal where parameters like temperature, vibrations and/or idler roller rotational speed are monitored and wirelessly communicated to a remote receiver (or transceiver) that can be located some metres to several kilometres away.

Conveyor data may then concentrated in an operations centre or remotely hosted. The conveyor data is then analysed to determine the likely failure timing so that a work-order may be scheduled, generated or sent to maintenance staff. As each conveyor roller has two bearings it would be preferable to include two sensor assemblies in each roller, preferably in the form of modified labyrinth seal telemetry units.

The invention also supports the retrofitting of the sensor assembly into an existing conveyor roller assembly, as well as being part of a brand-new conveyor roller during manufacture. Under certain circumstances, e.g. where battery life is paramount, the sensor assembly may have a simple transmitter which has been programmed broadcast the detected parameter data (generally corresponding to the conveyor roller status) every hour or so.

Another advantage of the invention is that detected or measured parameter data from the conveyor rollers can be processed in real-time or off-line, depending on the nature and complexity of the failure point prediction algorithms employed by the processor in analysing the detected parameter data.

By providing a sensor assembly that can be readily mounted and removed from an idler roller, the invention confers the advantages of accurate detection and/or measurement of various operational and other parameters of the idler roller and time saving, since the ability to communicate remotely with the sensors avoids the need for manual detection or measurement of each idler roller. This saving in time and labour also results in significant efficiencies in monitoring the belt conveyor system while reducing or eliminating any potential downtime and safety risks involved with manual measurement. Moreover, the invention permits more accurate measurements to be made and a greater range of measurements to be made simultaneously, in contrast to the prior art where measuring different parameters require different sensors operated by workers. Furthermore, the invention can be readily implemented to existing idler rollers and belt conveyor systems as described above. In all these respects, the invention represents a practical and commercially significant improvement over the prior art.

Although the invention has been described with reference to specific examples, it will be appreciated by those skilled in the art that the invention may be embodied in many other forms. As such, many modifications will be apparent to those skilled in the art without departing from the scope of the present invention.

1. A sensor assembly for an idler roller in a belt conveyor system, comprising:
a housing for mounting on a shaft of the idler roller, wherein the housing has:
one or more sensors for detecting one or more parameters of the idler roller, wherein at least one sensor comprises a temperature sensor for measuring the temperature of a bearing of the idler roller, the temperature sensor comprising a thermal transfer element for transferring heat from a bearing of the idler roller to the temperature sensor;
a wireless communication device; and
a processor in communication with the one or more sensors and the wireless communication device; wherein
the one or more sensors transmit the detected parameter data to the processor; and
the processer causes the detected parameter data to be transmitted by the wireless communication device.

2. The sensor assembly of claim 1, wherein the sensor assembly is mounted to a mechanical seal of the idler roller.

3. The sensor assembly of claim 1, wherein the housing is substantially annular in shape or has a ring-shape to define a central opening through which to receive the shaft of the idler roller.

4. The sensor assembly of claim 1, wherein the thermal transfer element comprises a thermal washer.

5. The sensor assembly of any one of the preceding claims, wherein the one or more sensors further comprises one or more of a temperature sensor for measuring the temperature of a bearing of the idler roller, wherein the rotation counter comprises one or more magnetically responsive elements operatively connected to two or more magnets, wherein the rotational velocity of the idler roller is calculated from the detected rotation of the two or more magnets, a rotation counter for measuring the rotations of the bearing of the idler roller, a rotational velocity sensor for measuring the rotational velocity of the idler roller, a vibration sensor for measuring vibrations experienced by the idler roller, an accelerometer for measuring the acceleration of the idler roller and an acoustic sensor for measuring acoustic data relating to the idler roller.

6. (canceled)

7. The sensor assembly of claim 5, wherein the two or more magnets are mounted to a magnet holder, wherein the magnet holder is substantially annular in shape or ring shaped and the one or more magnetically responsive elements comprise magnetically responsive coils mounted to a substrate of the sensor assembly and configured to detect the rotation of the two or magnets.

8. The sensor assembly of claim 1, further comprising an energy harvesting mechanism for converting rotational movement of the sensor assembly into electrical energy to charge and/or recharge an energy storage device.

9. The sensor assembly of claim 8, wherein the energy harvesting mechanism comprises a plurality of permanent magnets operatively coupled to one or more energy harvesting coils for converting rotational movement of the permanent magnets into electrical energy.

10. The sensor assembly of claim 9, wherein the one or more energy harvesting coils also count the rotation of the permanent magnets and transmits the rotation count data to the processor.

11. The sensor assembly of claim 5, wherein the rotational velocity of the idler roller is compared to the rotational velocity of one or more idler rollers in the belt conveyor system to determine the relative shell thickness of the idler roller.

12. The sensor assembly of claim 5, wherein an absolute shell thickness is calculated from the rotational velocity of the idler roller and the external shell radius of the idler roller, the external radius being determined by comparing the belt speed of a conveyor belt with the rotational velocity of the idler roller.

13. The sensor assembly of claim 1, wherein the wireless communication device comprises a transceiver in communication with an antenna assembly, wherein the antenna assembly comprises a plurality of antenna arrays, each antenna array comprising a plurality of antennae extending outside of the housing and configured to extend parallel to the shaft of the idler roller extending outside of the housing.

14. The sensor assembly of claim 13, wherein there are four antenna arrays arranged in quadrature around the shaft of the idler roller.

15. The sensor assembly of claim 13, wherein the antenna assembly is arranged on an inner side of the idler roller.

16. The sensor assembly of claim 13, wherein each antenna array comprises at least a director element and a driven element and wherein the antenna arrays share a common reflector element cylindrical in shape.

17.-18. (canceled)

19. A telemetry-enabled seal assembly for an idler roller in a belt conveyor system, comprising:
a mechanical seal for mounting on a shaft of the idler roller;
a housing connected to the mechanical seal, wherein the housing has:
one or more sensors for detecting one or more parameters of the idler roller;
wherein at least one of the one or more sensors comprises a temperature sensor for measuring the temperature of a bearing of the idler roller;
the one or more sensors further comprising one or more of a rotation counter for measuring the rotations of the bearing of the idler roller, a rotational velocity sensor for measuring the rotational velocity of the idler roller, a vibration sensor for measuring vibrations experienced by the idler roller, an accelerometer for measuring the acceleration of the idler roller and an acoustic sensor for measuring acoustic data relating to the idler roller;
a wireless communication device comprising a transceiver in communication with an antenna assembly;
the antenna assembly comprising a plurality of antenna arrays, each antenna array comprising a plurality of antennae extending outside of the housing and configured to extend parallel to the shaft of the idler roller; and
a processor in communication with the one or more sensors and the wireless communication device;
wherein the temperature sensor comprises a thermal transfer element for transferring heat from a bearing of the idler roller to the temperature sensor;
the rotation counter comprises one or more magnetically responsive elements and two or more magnets, the magnets being mounted to a magnet holder, wherein the one or more magnetically responsive elements are mounted on the housing and the magnet holder is mounted on a side of the mechanical seal opposite to the side of the mechanical seal connected to the housing;
the one or more sensors transmit the detected parameter data to the processor; and
the processer causes the detected parameter data to be transmitted by the wireless communication device.

20. (canceled)

21. The telemetry-enabled seal assembly of claim 19, wherein the mechanical seal is a labyrinth seal, the housing being connected to an inner face of the labyrinth seal and the antenna assembly is arranged on an inner side of the idler roller.

22. The telemetry-enabled seal assembly of claim 19, wherein the mechanical seal is a labyrinth seal, the housing being connected to an outer face of the labyrinth seal.

23. The sensor assembly of claim 19, wherein there are four antenna arrays arranged in quadrature around the shaft of the idler roller.

24. The sensor assembly of claim 19, wherein each antenna array comprises at least a director element and a driven element and wherein the antenna arrays share a common reflector element.

25. (canceled)
